(19) United States
(12) Patent Application Publication
(10) Pub. No.: US 2004/0263888 A1
(43) Pub. Date: Dec. 30, 2004

(54) Apparatus and method for printing an image on a print medium

(76) Inventors: Kirk S. Tecu, Greeley, CO (US); William R. Haas, Fort Collins, CO (US); Scott C. Baggs, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/610,436

(22) Filed: Jun. 30, 2003

(51) Int. Cl. G06F 15/00

(52) U.S. Cl. 358/1.12; 358/1.8

(57) ABSTRACT

An apparatus for printing an image on a print medium comprising a printer system having a print head for printing as the apparatus is moved relative to a surface of the print medium is provided. The apparatus comprises a navigation sensor for detecting movement of the apparatus. The image is re-calculated in accordance with the detected movement.

### TECHNICAL FIELD OF THE INVENTION

This invention relates to imaging technologies and, more particularly, to an apparatus and method for printing an image on an object.

### BACKGROUND OF THE INVENTION

Multi-function peripheral imaging devices are common in today's computing environments. For example, some printing devices (such as laser printers or ink jet printers) are now integrated with copying, scanning and/or faxing devices. However, multifunctional devices are generally large, mechanically and electronically complex units. Moreover, numerous scenarios often arise where traditional multi-functional devices are impractical or cumbersome to use. For example, scanning and printing on small media, such as postcards, envelopes, or other relatively small objects, is often difficult to perform on conventional multi-functional devices and may require manual adjustments to various media feed guides. Likewise, scanning and/or printing on over-sized media, such as poster sized media, may be difficult or impossible with existing scanning or printing office equipment.

### SUMMARY OF THE INVENTION

In accordance with an embodiment of the present invention, an apparatus for printing an image on a print medium comprising a printer system having a print head for printing as the apparatus is moved relative to a surface of the print medium is provided. The apparatus comprises a navigation sensor for detecting movement of the apparatus. The image is re-calculated in accordance with the detected movement.

In accordance with another embodiment of the invention, a method of printing an image on a print medium with a printer apparatus comprising printing a portion of the image during a first traversal of the apparatus across the medium and re-calculating at least a portion of the image commensurate with a re-orientation of the apparatus is provided. A portion of the re-calculated image is printed during a second traversal of the apparatus across the medium.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified perspective view of a portable printing apparatus implemented according to an embodiment of the present invention;

FIG. 2 is simplified bottom schematic view of the apparatus of FIG. 1;

FIG. 3 is a simplified block diagram of the apparatus of FIG. 1;

FIG. 4 is a simplified block diagram of a printer system implemented in a portable imaging apparatus according to an embodiment of the present invention;

FIG. 5A is a schematic of an image that is printed in accordance with an embodiment of the present invention;

FIG. 5B is a schematic of a portion of the image described in FIG. 5A that is transformed for printing commensurate with changes in position and orientation made to a portable printing apparatus;

FIG. 6A is a schematic of a print medium having a printer apparatus positioned and swept across the print medium for printing a portion of an image in accordance with an embodiment of the invention;

FIG. 6B is a schematic of the print medium of FIG. 6A after printing of a portion of an image and repositioning the printer apparatus;

FIG. 6C is a schematic of the print medium of FIGS. 6A and 6B after printing a second image portion thereon in accordance with an embodiment of the invention; and

FIG. 7 is a flowchart of processing steps performed during printing of an image according to an embodiment of the present invention.

### DETAILED DESCRIPTION OF THE DRAWINGS

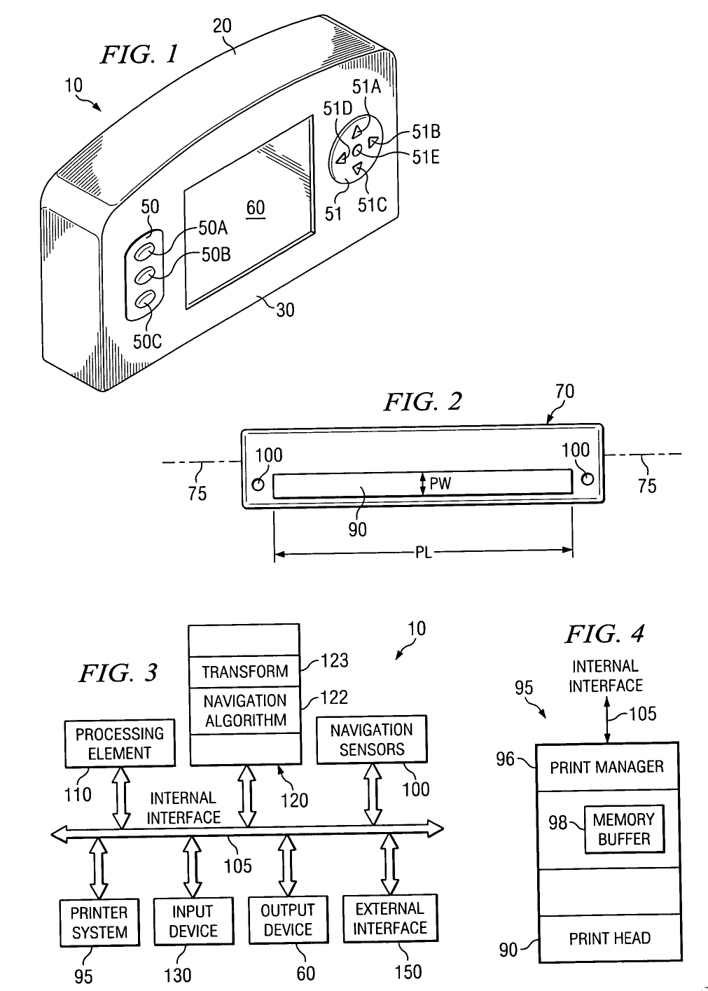

The preferred embodiment of the present invention and its advantages are best understood by referring to FIGS. 1 through 7 of the drawings, like numerals being used for like and corresponding parts of the various drawings.

FIG. 1 is a simplified perspective view of a portable printing apparatus 10 implemented according to an embodiment of the present invention. Apparatus 10, in general, has an external housing 20 including a front surface 30. Surface 30 may have one or more input elements for receiving input from a user and one or more output elements for providing visual feedback to the user. For example, surface 30 has keypads 50 and 51 with control button(s) 50A-50C and 51A-51E disposed thereon. Other types of input elements, such as a touch sensitive panel, may be substituted for keypads 50 and 51.

An output device 60, such as a liquid crystal display, is preferably disposed on surface 30. Output device 60 is operable to provide visual output to the user. Output device 60 may provide a visual indication of a selected operational mode and operational status such as a visual progress indication of a printed image. Output device 60 may also provide other types of information indicative of an operational state of apparatus 10.

FIG. 2 is a simplified bottom schematic view of apparatus 10. A bottom surface 70 has one or more navigation sensors 100 disposed thereon. Navigation sensors 100 detect and provide output data indicative of the position of apparatus 10 relative to a print medium, e.g., a paper document. Preferably, navigation sensors 100 are implemented as optical sensors operable to determine two-dimensional positional displacement or orientation measurements of apparatus 10. Less sophisticated, mechanically-actuated positional sensors, such as wheel sensors that perform one-dimensional measurements based on rotation of a mechanical wheel, may also be used. The position and orientation information generated by navigation sensors 100 is preferably conveyed to a processor and is used to properly calculate the image orientation. Thus, changes in position and orientation of apparatus 10 are accounted for by apparatus 10 so that the image is properly printed on the print medium regardless of movements made to apparatus 10. The processor may be disposed within apparatus 10 or may be disposed within a separate computational device communicatively coupled with apparatus 10. Apparatus 10 further comprises a print head 90 having a print length (pl) and a print width (pw). Print head 90 may comprise an elongate structure generally aligned with a transverse axis 75 of apparatus 10.

FIG. 3 is a simplified block diagram of apparatus 10 according to an embodiment of the present invention. Apparatus 10 comprises a processor or processing element 110 such as a conventional central processing unit. Processing element 110 fetches and executes computer-readable instructions maintained in a memory device 120, such as a random-access memory, a read-only memory, an electrically programmable read-only memory, or another storage device. Processing element 110 communicates with and drives other elements within apparatus 10 via a local interface 105, which may comprise one or more buses. An input device 130, for example keypads 50 and 51, a keyboard, a touchscreen or another device, is operable to receive input data from the user An output device 60, for example a liquid crystal display, is operable to provide visual output to the user. Navigation sensors 100, such as roller wheel mechanism, optic sensors, or other devices, are operable to detect the position or orientation of apparatus 10 relative to the print medium, and provide the detected position or orientation information to processing element 110. An image is formatted by processing element 110 in conjunction with a navigation algorithm 122 and a transform algorithm 123 that orients an image in accordance with the position and orientation of apparatus 10 prior to printing by a printer system 95. Preferably, transform algorithm 123 is a software application adapted to recalculate an image in accordance with changes made to the position or orientation of apparatus 10 communicated to transform algorithm 123 by navigation algorithm 122. Accordingly, transform algorithm 123 re-calculates an image according to changes in the position or orientation of apparatus 10. Preferably, position and orientation measurements are provided as respective offsets, or changes, measured with respect to an initial position and orientation of apparatus 10.

Processing element 110 preferably receives position information indicative of the relative position of apparatus 10 with respect to a print medium from sensors 100. As apparatus 10 is moved relative to the print medium, sensors 100 identify and track the relative movement of apparatus 10. Processing element 110 compares the new positions with previously identified positions and is adapted to update the position, orientation, direction of movement, or velocity of apparatus 10 relative to the print medium. Any one of various position navigation techniques may be implemented by navigation sensors 100, processing element 110, and navigation algorithm 122, and an exemplary navigation system is described in U.S. Pat. No. 6,195,475 to Beausoleil, Jr. et al.

FIG. 4 is a simplified block diagram of printer system 95 according to an embodiment of the present invention. Printer system 95 comprises a print head 90, such as a drop-on-demand assemblage. A print manager 96, or print controller, receives data via interface 105 and is operable to control various subsystems of printer system 95. Additionally, print manager 96 may include printer driver circuitry and/or software for converting data received via interface 105 into a format suitable for printing. Alternatively, the printer driver functionality may be disposed within other components of apparatus 10 or may be disposed external to apparatus 10. For example, the printer driver may be run by processing element 110 and maintained in memory device 120, or the printer driver may be run by a processing element of a computer communicatively coupled with apparatus 10 via an external interface 150. Print manager 96 may further comprise a memory buffer 98 which may comprise a random access memory module(s) or another suitable memory device. Alternatively, memory device 120 may be adapted to provide buffer 98.

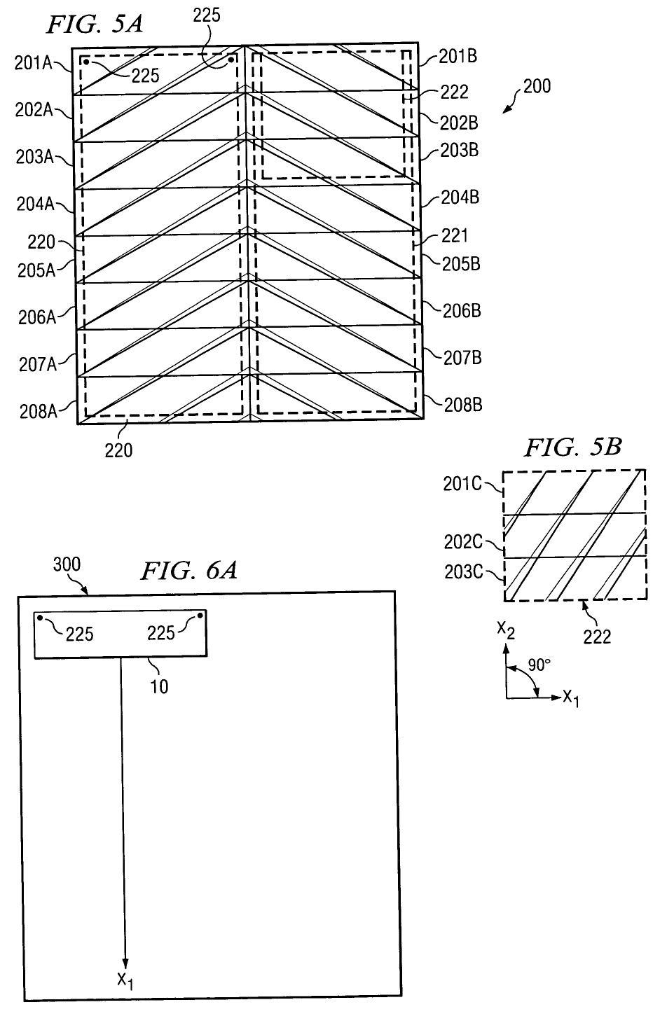

An image 200 to be printed by portable apparatus 10 may exceed print head 90 dimensions and, accordingly, may be divided into a plurality of partitions 201A-208B as shown by FIG. 5A. Image 200 may be generated by transform algorithm 123 from a source image, such as a bitmap image, JPEG image, a text file or another image source, and is divided into a plurality of partitions 201A-208A and 201B-208B by transform algorithm 123 suitably dimensioned for printing by print head 90. Image 200 is stored in memory device 200 or conveyed to apparatus 10 via external interface 150. In the present example, image 200 is illustratively represented as a series of diagonal lines.

The printing of a partition of an image is herein referred to as a print operation. The printing of a complete image requires performing a plurality of print operations for an image exceeding the dimensions of print head 90. The execution of a plurality of print operations to print a complete image is referred to herein as a print routine. Image 200 is defined as a numerical representation such as a bitmap, i.e., a data set comprising ordered sets of rows of pixels each having a numerical value that defines a color. The pixels of the image data set may respectively comprise a single numerical value for defining a black and white image or a gray scale image. Alternatively, the pixels of the image data set may respectively comprise a plurality of numerical values for defining a color image. For example, each pixel comprises a “triple,” that is, three numerical values for defining the red, green, and blue (RGB) component values of a pixel. Image attributes, such as image size, aspect ratio, or another image characteristic, may be manipulated by transform algorithm 123 to facilitate the printing of desired image characteristic(s) on the print medium.

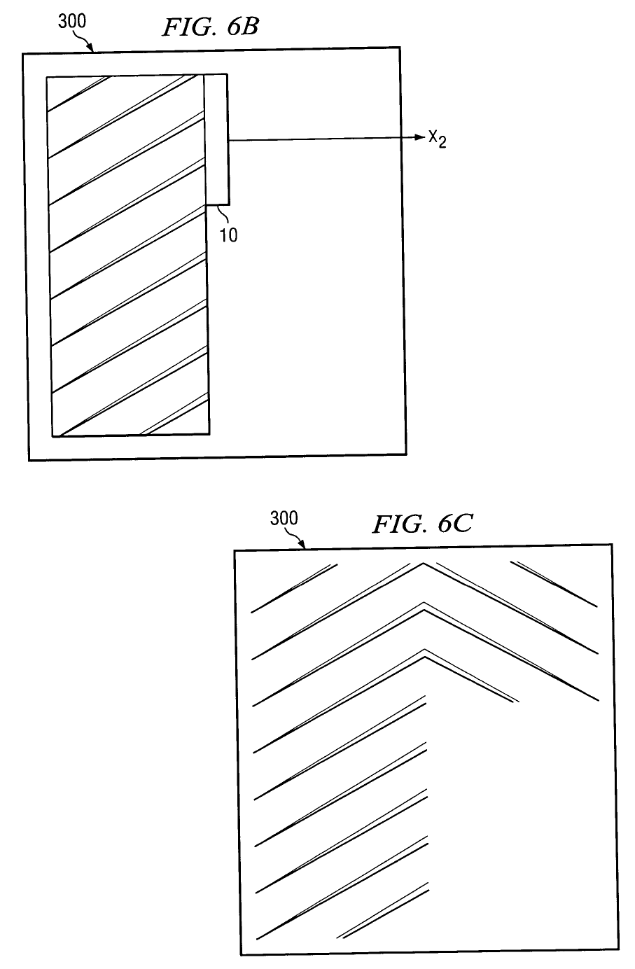

The number of pixel rows contained in a partition is limited to the physical configuration of print head 90. For illustrative purposes, each partition 201A-208B is assumed to comprise dimensions corresponding to print head 90 dimensions. Accordingly, partitions 201A-208B represent the largest portion of image 200 able to be printed by apparatus 10 at any given time. The printing of adjacent partitions, e.g., partitions 201A and 202A, is performed by providing a relative movement between apparatus 10 and a print medium 300 on which image 200 is to be printed as shown by the illustrative schematic in FIG. 6A. Typically, the relative movement between print medium 300 and apparatus 10 is provided by sweeping, or traversing, apparatus 10 across a surface of print medium 300. A partition is printed by accumulating rows of pixel data in buffer 98 until the accumulated pixel rows are printed by apparatus 10. After printing of a partition, e.g., partition 201A, pixel data of partition 202A is accumulated in buffer 98 until print head 90 is suitably positioned for printing of partition 202A adjacent to the printed partition 201A. Subsequent partitions, e.g., partitions 203A-208A, are sequentially printed until the final partition 208A of a partition sequence is printed or until apparatus 10 is repositioned or re-oriented. In the event that apparatus 10 is repositioned or re-oriented, image 200 is preferably re-calculated to compensate for the new position or orientation of apparatus 10 in accordance with an embodiment of the invention.

With reference again to FIG. 6A, assume apparatus 10 is moved through a linear sweep x₁. As apparatus 10 moves through sweep x₁, an image portion 220 comprising partitions 201A-208A is printed on print medium 300. Image portion 220 is printed by sequentially printing partitions 201A-208A. FIG. 6B is an illustrative schematic of print medium 300 after completion of printing image portion 220. In the present example, half of image 200, i.e., portion 220, is printed during sweep x₁ and an image half 221 remains to be printed.

Further assume that after printing of image partitions 201A-208A, the user re-orients apparatus 10 perpendicular to the original apparatus orientation and repositions apparatus 10 as shown in FIG. 6B. Information calculated by navigation algorithm 122 indicative of the new position and orientation of apparatus 10 is supplied to transform algorithm 123. Upon detection of a reposition or re-orientation of apparatus 10 by navigation algorithm 122, a transform of image 200 (or a portion thereof) is then made by transform algorithm 123. In the illustrative example, the data of the image remaining to be printed must be rotated by 90 degrees to maintain the original orientation of image 200 with print medium 300. An image portion 222 to be printed during a sweep x₂ is first transformed commensurate with changes made to the position and orientation of apparatus 10 and divided into partitions 201C-203C as illustrated by the schematic of transformed image portion 222 in FIG. 5B. Notably, image portion 222 is transformed in accordance with the position and orientation of apparatus relative to print medium 300 and thereafter conveyed to printer system 95 for printing. That is, image portion 222 is re-calculated to account for the change in position and orientation of apparatus 10 made from the completion of sweep x₁ to the beginning of sweep x_{2.}

During sweep x₂, second portion 222 is printed on print medium 300 as shown by the illustrative schematic of FIG. 6C. Partitions 201C-203C are printed on print medium 300 such that the orientation of image portion 222 with respect to the previously printed image portion 220 is consistent with image 200. The user may continue to reposition and re-orient apparatus 10 and perform additional sweeps of apparatus 10 until the printing of image 200 is completed.

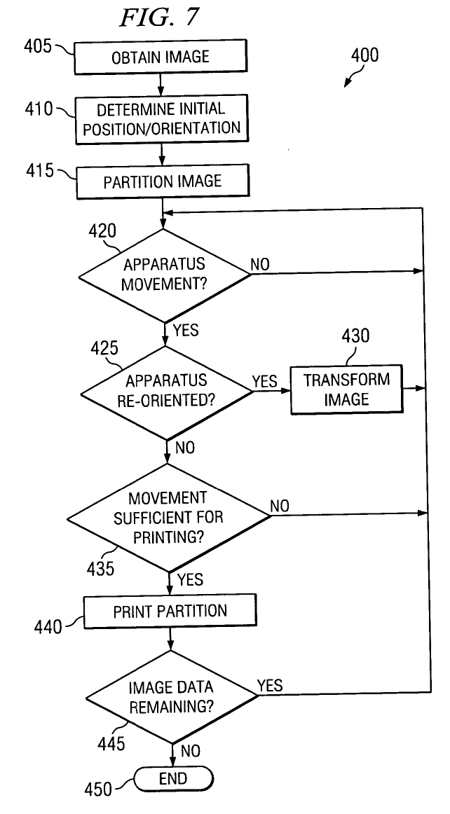

With reference now to FIG. 7, there is a flowchart 400 of processing steps performed by apparatus 10 and/or an external computational device connected therewith during printing of an image according to an embodiment of the present invention. The printing process is initiated by obtaining an image to print (block 405). An initial orientation and/or position of apparatus 10 is then determined by navigation sensors 100 (block 410). Determination of an initial orientation and/or position of apparatus 10 may comprise assigning an origination coordinate(s) and/or an initial orientation value to a respective position and orientation detected by navigation sensors 100 at invocation of a print routine. For example, an origination coordinate(s) 225 (FIG. 6A) may be detected on medium 300 after receipt of a print command by apparatus 10 provided by the user. Preferably, an orientation of image 200 is associated with origination coordinate 225 that is maintained throughout the print routine. Partition data may then be generated and associated with the initial position and/or orientation data of apparatus 10 (block 415). A polling procedure that evaluates whether apparatus 10 has been moved relative to print medium 300 may then commence (block 420) and, upon determining that apparatus 10 has been moved, an evaluation is made to determine whether apparatus 10 has been re-oriented (block 425). If apparatus 10 has been re-oriented, the image data may be transformed or otherwise re-calculated according to the new orientation (block 430), accumulated in buffer 98, and the printing routine may return to polling for movement of apparatus 10. Transforms of image 200 may be made from trigonometric relations between a newly calculated position or orientation of apparatus 10 with respect to the initial position and orientation of apparatus 10, e.g., by displacements measured by navigation sensors 100 from the origination coordinate 225. If it is determined that apparatus 10 has not been re-oriented, an evaluation is made to determine whether the detected movement is sufficient for printing of an image partition (block 435). If the movement of apparatus 10 is insufficient for printing of a partition, the procedure returns to polling for apparatus 10 movement. If, however, the detected apparatus movement is sufficient for printing of partition data, the partition data is printed by printer system 95 for processing and printing thereof (block 440). The procedure may then return to polling for apparatus 10 movement if image data remains to be printed (block 445) or, alternatively, the print routine terminates if printing is completed (block 450). It should be understood that the particular processing routine described with reference to FIG. 7 is exemplary only and numerous variations or substitutions may be made for implementing the invention.

What is claimed is:

1. An apparatus for printing an image on a print medium, comprising:
a printer system having a print head for printing on the print medium as the apparatus is moved relative to a surface of the print medium; and
a navigation sensor for detecting movement of the apparatus, the image re-calculated in accordance with the detected movement.

2. The apparatus according to claim 1, wherein the navigation sensor comprises a mechanically-actuated sensor.

3. The apparatus according to claim 1, wherein the navigation sensor comprises an optical sensor, the movement detected by the navigation sensor comprising a two-dimensional measurement.

4. The apparatus according to claim 1, further comprising a navigation algorithm, the navigation sensor adapted to convey position information representative of the detected movement to the navigation algorithm, the navigation algorithm adapted to calculate a change in orientation of the apparatus with respect to the print medium based upon the detected movement.

5. The apparatus according to claim 1, further comprising:
a processing element; and
a transform algorithm executed by the processing element, re-calculation of the image performed by the transform algorithm based upon the detected movement.

6. The apparatus according to claim 5, wherein the transform algorithm is adapted to divide the image into partitions suitably dimensioned for printing by the print head.

7. The apparatus according to claim 1, wherein the apparatus further comprises a memory device operable to accumulate pixel data of the image for printing.

8. The apparatus according to claim 1, further comprising an input device adapted to receive a print command from a user, an orientation between the print medium and the image to be printed thereon determined upon receipt of the print command.

9. The apparatus according to claim 1, wherein the apparatus is adapted to receive a print command from a user, an initial position and orientation of the apparatus with respect to the print medium is determined upon receipt of the print command, re-calculation of the image performed upon a determination of a change in the orientation of the apparatus.

10. The apparatus according to claim 1, wherein the apparatus is adapted to receive a print command from a user, an initial position and orientation of the apparatus with respect to the print medium is determined upon receipt of the print command, re-calculation of the image performed upon a determination of a change in position of the apparatus.

11. A method of printing an image on a print medium with a printer apparatus, comprising:
printing a portion of the image during a first traversal of the apparatus across the medium;
re-calculating at least a portion of the image commensurate with a re-orientation of the apparatus; and
printing at least a portion of the re-calculated image during a second traversal of the apparatus across the medium.

12. The method according to claim 11, further comprising detecting a change in the position of the apparatus with respect to the medium.

13. The method according to claim 11, further comprising accumulating, in a memory buffer, pixel data of the image portions printed during the first and second traversals prior to printing the image portions.

14. The method according to claim 11, further comprising dividing the portion into a plurality of partitions prior to printing the portion during the first traversal.

15. The method according to claim 14, wherein printing the image portion during the first traversal further comprising sequentially printing the plurality of partitions.

16. The method according to claim 11, wherein re-calculating at least a portion of the image further comprises:
receiving position information indicating a change in orientation of the apparatus with respect to the medium; and
calculating a portion of the image based upon the position information.
